(19) United States
(12) Patent Application Publication
(10) Pub. No.: US 2012/0036725 A1
(43) Pub. Date: Feb. 16, 2012

(54) KICKBACK DETECTION METHOD AND APPARATUS

(75) Inventors: Ian Osborne, Hillsboro, OR (US); Drew Arnold, Portland, OR (US); Gale Hall, Portland, OR (US)

(73) Assignee: BLOUNT, INC., Portland, OR (US)

(21) Appl. No.: 13/208,308

(22) Filed: Aug. 11, 2011

Related U.S. Application Data
(60) Provisional application No. 61/372,852, filed on Aug. 11, 2010.

(51) Int. Cl. B27B 17/02; B27G 19/00

(52) U.S. Cl. 30/383; 83/62.1

(57) ABSTRACT

In various embodiments, a cutting tool such as a chainsaw may include a cutting member that is movable by an engine, one or more sensors configured to detect one or more of acceleration in a direction parallel to one or more axes of the cutting tool and rotational velocity about one or more axes of the cutting tool, and a microprocessor configured to cause movement of the cutting member to stop in response to receiving one or more signals from the one or more sensors. In various embodiments, a method may include receiving, by a microprocessor of a chainsaw, a signal from a gyroscope configured to detect rotational velocity about one or more axes of the cutting tool, and actuating, by the microprocessor, a braking system of the chainsaw to stop movement of a cutting chain around a perimeter of a guide bar in response to the signal.

### CROSS REFERENCE TO RELATED APPLICATIONS

The present application claims priority to U.S. Provisional Patent Application No. 61/372,852, filed Aug. 11, 2010, entitled “Kickback Detection Method and Apparatus,” the entire disclosure of which is hereby incorporated by reference in its entirety.

### TECHNICAL FIELD

Embodiments herein relate to the field of chainsaws and other handheld power tools used for cutting a variety of materials such as wood, concrete, metal, and the like that may experience rapid rotational and/or horizontal reaction forces, and in particular, to detecting and responding to such reaction forces.

### BACKGROUND

The most common safety risk when working with chainsaws is an occurrence called kickback. Kickback is generally defined as “the rapid upward and [/or] backward motion of the chain-saw which can occur when the moving saw chain near the tip of the guide bar contacts an object such as a log or a branch.” See International Standards Organization in ISO 6531 Machinery for forestry—Portable hand-held chain-saws—vocabulary.

While the worst kickback incidents resulting in serious injury or even death are rare, any kickback incident is perceived by the operator of the chainsaw as a frightening loss of control of the tool. To prevent such an event from occurring, the industry has invested years developing “safety” chain to reduce the likelihood of kickback. The unfortunate tradeoff has been reduced cutting performance. Additionally, manufacturers of chainsaws and other handheld tools have instituted braking systems that stop the chain. These systems, however, are generally slow to react and often do not adequately prevent frightening loss of control or even injury.

### BRIEF DESCRIPTION OF THE DRAWINGS

Embodiments herein will be readily understood by the following detailed description in conjunction with the accompanying drawings. Embodiments are illustrated by way of example and not by way of limitation in the figures of the accompanying drawings.

FIG. 1 illustrates a chainsaw in accordance with various embodiments.

FIG. 2 illustrates a chainsaw in accordance with various embodiments.

FIG. 3 illustrates a chainsaw with superimposed axes, in accordance with various embodiments.

FIG. 4 depicts schematically an example of components that may be implemented in a cutting tool such as a chainsaw, in accordance with various embodiments.

FIG. 5 depicts a view of various components of a chainsaw braking system, in accordance with various embodiments.

FIGS. 6 and 7 depict schematically an example method that may be implemented by a cutting tool such as a chainsaw, in accordance with various embodiments.

FIGS. 8 and 9 depict an example secondary system for stopping a chainsaw, in accordance with various embodiments.

FIGS. 10-12 depict example testing data and weighting factors that may be utilized in methods for detecting kickback, in accordance with various embodiments.

### DETAILED DESCRIPTION OF EMBODIMENTS

In the following detailed description, reference is made to the accompanying drawings which form a part hereof, and in which are shown by way of illustration embodiments in which the disclosure may be practiced. It is to be understood that other embodiments may be utilized and structural or logical changes may be made without departing from the scope of the present disclosure. Therefore, the following detailed description is not to be taken in a limiting sense, and the scopes of embodiments, in accordance with the present disclosure, are defined by the appended claims and their equivalents.

Various operations may be described as multiple discrete operations in turn, in a manner that may be helpful in understanding embodiments herein; however, the order of description should not be construed to imply that these operations are order dependent.

The description may use perspective-based descriptions such as up/down, back/front, and top/bottom. Such descriptions are merely used to facilitate the discussion and are not intended to restrict the application of embodiments herein.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

In various embodiments, an electronic sensor may be coupled to a cutting tool, such as a chainsaw, and may be adapted to detect rapid motion or a change in direction that is outside a set “normal” parameter. Upon detection, the sensor may send a signal to a microprocessor of the cutting tool to take a responsive action, such as activating a brake and/or shutting down an engine. As used herein, to “shut down” an engine may include removing power supplied to the engine and/or actively stopping movement of components attached to the engine (e.g., by decoupling a motor from an output shaft). As used herein, an “engine” may refer to any machine that converts energy into useful mechanical motion, such as a gas- or electric-powered motor.

In various embodiments, the sensor may be a micro-machined electro-mechanical system (“MEMS”) sensor, such as an accelerometer and/or a gyroscope. MEMS sensors may be small and easily integrated into existing circuitry and output a voltage that may be scaled depending on the sensor. The braking function may be performed by various types of brakes, such as a band brake wrapped around a drum and/or a permanent magnet motor as a regenerative brake.

It has been found that a kickback event is generally not caused by a singular cutting tooth of the cutting chain reacting with the material being cut. Rather, it may involve as many as half of the cutters on the chain. The rotational energy of the chain may be transferred into the chainsaw, which may utilize the material being cut as a ladder forcing the nose of the bar, and consequently the saw, rotationally up and towards the operator. This transfer of energy can be stopped by stopping the rotation of the cutting chain once it begins to interact with the material in a manner that will cause a kickback event.

Accelerometers, in accordance with various embodiments, may be sensitive enough to detect any movement within a cutting tool such as a chainsaw, including the cutting chain moving through wood. Accordingly, various mechanisms may be utilized to prevent unnecessary braking of the cutting chain. Some embodiments may use two mechanisms to eliminate “noise” associated with normal cutting: sensor placement and filtering. Some embodiments may include sensors at strategically selected locations where the sensors may be more likely to accurately detect kickback.

Some embodiments may use one or more low pass filters to reduce signal noise. In some embodiments, a low pass filter frequency may be between 75 Hz and 200 Hz. In some embodiments, a low pass filter frequency of 150 kHz may be used. In some embodiments, a second order Butterworth filter may be used to provide low pass filtering.

In one embodiment, the accelerometer may be a MEMS sensor that is a sealed unit that uses a cantilevered beam with a proof mass and gas that is sealed. In some embodiments, accelerometers may be one or more of the following: ADXL001-250 (22 Khz bandwidth) or AD22281 (0.4 kHz), both by Analog Devices. Other sensor models and versions may be used without departing from the disclosure. In some embodiments, additional reduction in vibration may be achieved by mounting a sensor to a rubber or polymer to dampen unwanted high-frequency vibrations.

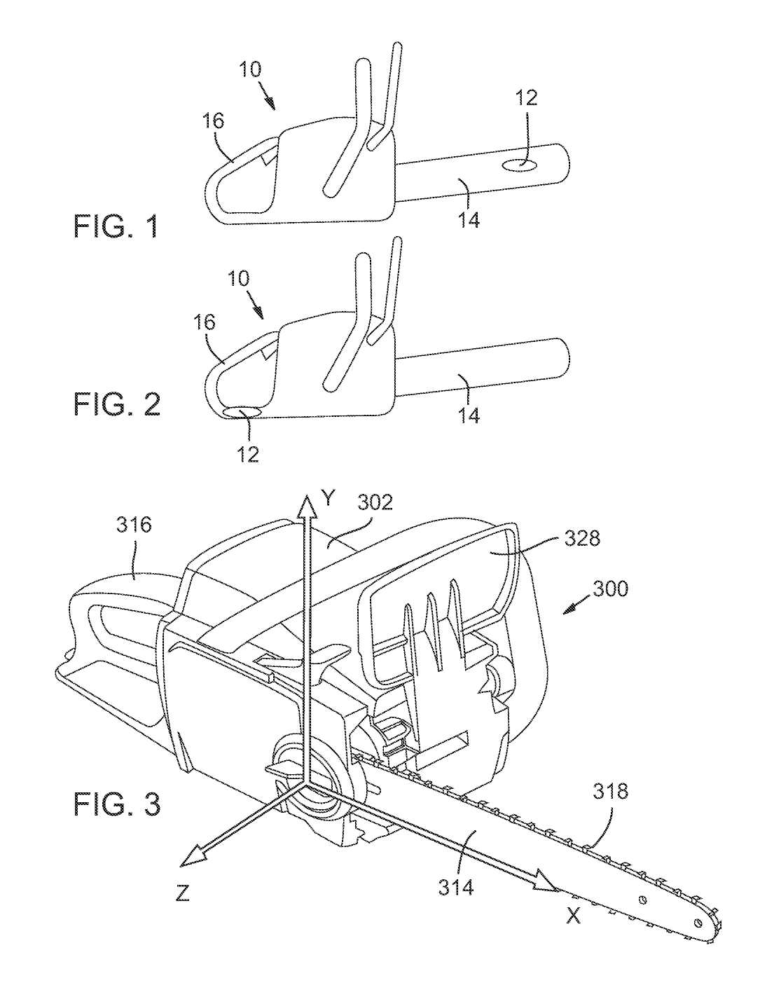

In the most common mode of cutting, nose clear bucking, the sensor may be mounted in various locations of the chainsaw in relation to the front handle. The front handle may be the approximate center of rotation during a kickback event. In various embodiments, the sensor may be positioned as far from the front handle as possible in order to provide for the detection of the greatest acceleration and/or physical displacement. In various embodiments, such as the chainsaw 10 shown in FIG. 1, a sensor 12 may be mounted in the guide bar 14, and in some embodiments in the tip of the guide bar 14. In various embodiments, such as that shown in FIG. 2, the sensor 12 may be mounted in the rear handle portion 16 of the chainsaw 10. In other embodiments, the sensor may be positioned in the body of the chainsaw.

The sensor may be coupled to a braking system or other stoppage mechanism by way of hard wired systems or wireless systems that include micro transmitters and receivers. For example, where the sensor is mounted in the bar of the chainsaw, as shown in FIG. 1, a wireless coupling may be used between the sensor 12 and a microprocessor in a body of the chainsaw 10 to facilitate bar replacement. In various embodiments, the sensor 12 may be modular and adapted to be releasably coupled to the guide bar 14 such that the sensor 12 may be moved to a new bar if the old bar is worn or damaged such that it needs replacement.

As a cutting mode, boring may be different in terms of the noise it generates, and consequently, the noise perceived by sensors. The noise created during boring may be an order of magnitude greater than other cutting techniques. The greater level of noise may be reduced with the use of appropriate signal filtering. The filtering may only detect a “significant” event and ignore normal cutting noise. For example, in some embodiments, one or more low pass filters may be used to reduce false positives.

In various embodiments, in addition to or instead of an accelerometer, other types of sensors can be used. For example, gyroscopes may be used to detect roll, pitch, yaw, or rotational velocity about an axis of the chainsaw. In some embodiments, gyroscopes may be one or more of the following: ADXRS620 (2.5 Khz bandwidth) or ADXRS652 (2.5 kHz), both by Analog Devices. Other sensors may be used without departing from the disclosure.

Additionally or alternatively, capacitive or piezoelectric sensors may detect acceleration change, velocity change, pressure change, voltage, current, and so forth. In various embodiments, the sensor may be a strain gage mounted in the bar, and may be configured to detect the kickback event and stop the chainsaw.

In the kickback detection circuit, the mounting location may depend on, for example, whether a single axis or a multi axis accelerometer will be used. If the sensor is near an extreme point of the chainsaw, such as the bar tip or the back of the rear handle, a single axis sensor may be used. However, if the sensor is mounted close to the front handle, a two axis sensor may be used. In various embodiments, the two axis sensor may use a signal-combination method to detect the horizontal and rotational movement of the chainsaw.

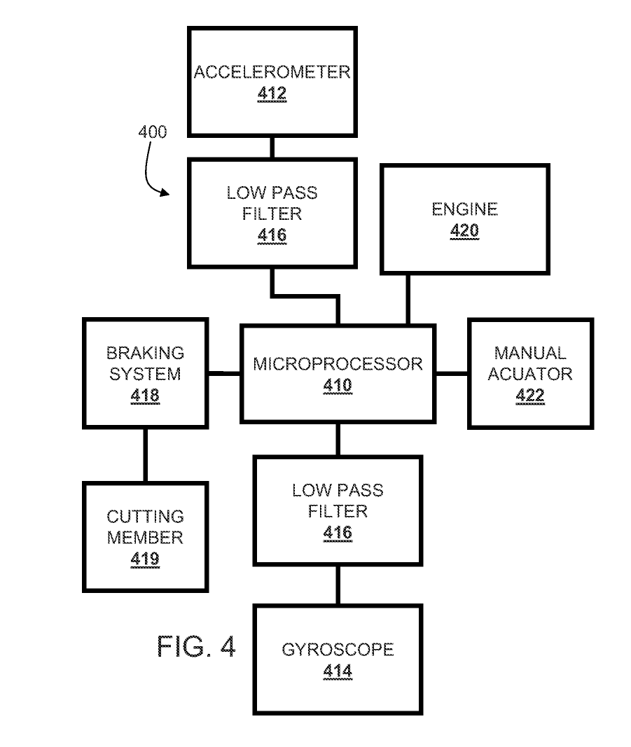

FIG. 3 depicts an example embodiment of a chainsaw 300 with superimposed example axes. Although the chainsaw 300 may include numerous parts and components, those that are most relevant to this disclosure are numbered. For example, the chainsaw 300 includes a housing 302, guide bar 314, a handle 316 and a cutting chain 318 that is operated by an engine (e.g., 420 in FIG. 4) contained in the housing 302 to move the cutting chain 318 around a perimeter of the guide bar 314. The chainsaw 300 also may include a hand guard 328, which may be movable forward and backward, as will be discussed below, to stop operation of the chainsaw. As noted above, MEMS sensors such as accelerometers and gyroscopes may be configured to detect acceleration and/or rotation along and about various axes. For example, in FIG. 3, an accelerometer may be configured to detect movement along the Y-axis, while a gyroscope may be configured to detect rotational velocity about an axis such as the Z-axis.

An example circuit 400 that may be used with a cutting tool such as a chainsaw is shown in FIG. 4. A microprocessor 410 may monitor various sensors, such as an accelerometer 412 and a gyroscope 414, and may execute a method to identify a kinematic signature consistent with kickback.

The accelerometer 412 may be used to measure acceleration in various directions, such as a direction parallel to the Y-axis shown in FIG. 3. The output units of the accelerometer 412 may be in g-force, or “G's.” The gyroscope 414 may detect a rotational velocity (°/second) of the chainsaw about various axes, such as the Z-axis in FIG. 3. One or both sensors may include or be connected to a low pass analog filter 416, which may attenuate the high frequency, high magnitude signals that may be produced by a cutting tool such as a chainsaw during use.

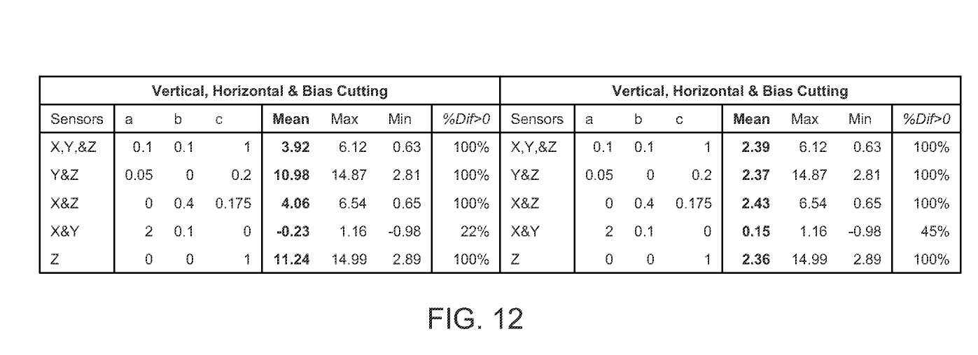

The microprocessor 410 may be configured to measure voltages output from the accelerometer 412 and the gyroscope 414. In some embodiments, the voltages may be converted from analog signals to digital signals that may then be processed. In some embodiments, signals may be converted using, e.g., values provided by a manufacturer of a sensor, to particular units. For example, a signal from an accelerometer may be converted to g's, and a signal from a gyroscope representing rotational velocity may be converted to degrees/second. In various embodiments, signals from the sensors may be scaled, e.g., by being multiplied by weighting factors, and then summed. For example, in some embodiments, the signal from the accelerometer may be multiplied by an additional weighting factor of 0.25. Other possible weighting factors may be used, and examples are shown in FIG. 12. Scaled signals may be combined into a single value, which may be referred to as KB (kickback). In various embodiments, the signals scaled by weighted factors may be combined using addition or subtraction.

A threshold may be set for the value of KB. For example, during normal operation of a chainsaw, KB may not exceed a certain percentage (e.g., 60%) of a threshold value for a typical kickback. A threshold in various embodiments may be determined through testing and/or by selecting a threshold that corresponds to a maximum acceptable level of motion that may occur during normal operation. In some embodiments, the threshold may be selected so that it will rarely be reached during normal operation.

If KB exceeds a threshold value, the microprocessor 410 may output a signal to a braking system 418 to stop a cutting member 419 (e.g., a cutting chain of a chainsaw) and another signal to an engine 420 to shut down. A manual actuator 422, which will be discussed further below, may also be provided, and may be actuated by a user, or by an industry-standard inertial brake mechanism, to send a signal to the microprocessor 410 to activate the braking system 418 and/or shut down the engine 420.

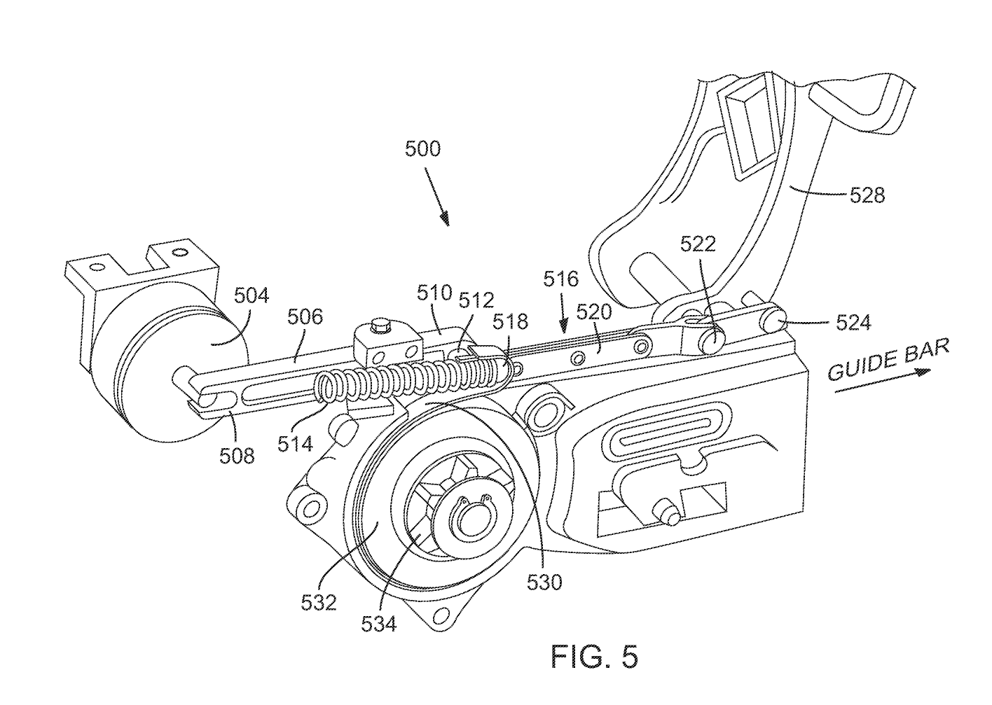

In some embodiments, the microprocessor 410 may use a 5VDC signal to actuate the braking system 418. In some embodiments, a double pole double throw relay may be actuated to remove power from the engine 420 to cause it to shut down. The double pole double throw relay may also apply power to a solenoid (504 in FIG. 5), which may actuate the braking system 418. The 5VDC signal may be sent until power to the microprocessor 410 is removed.

Gas-powered chainsaws may include electrical and/or electronic devices to stop the saw once the kickback is detected. For example, electricity supplied to a spark plug may be cut with a switch, such as a switch actuated by the manual actuator 422, to remove the ability of the spark plug to continue to ignite the fuel. The switch may be mechanical but a transistor may also be used. Corded electric chainsaws may be stopped in a similar manner using a switch to disconnect the power and by applying a mechanical band clamp for the brake. A brake mechanism such as a disc brake may also be used in various embodiments.

FIG. 5 depicts one example of a braking system 500 that may be incorporated into a chainsaw. A solenoid 504 may be actuated, e.g., by the microprocessor 410. Upon actuation, the solenoid 504 may apply force to a lever bar 506 at a first end 508. The lever bar 506 may pivot about a pivot point, causing a second end 510 of the lever bar 506, opposite the first end 508, to move in a direction opposite that of the first end 508. The second end 510 may be operably coupled to a pin 512, so that when lever bar 506 is pivoted, the pin 512 may be released from a position (e.g., in a hole) in which it had been preventing a compression spring 514 from triggering a spring-loaded linkage 516. In some embodiments, the lever bar 506 may have a two-to-one ratio, which may permit the solenoid 504 to apply 50% of the force required to remove the pin 512. In some embodiments, the pin 512 may be constructed with stainless steel. In other embodiments, other ratios and/or pin materials may be utilized.

The spring-loaded linkage 516 may include a first bar 518 positioned within the coils of the spring 514, a second bar 520, a first pivot pin 522 and a second pivot pin 524. The first pivot pin 522 may be both rotatable about its axis and movable laterally. The second pivot pin 524 may be rotatable about its axis but otherwise immovable. The spring 514 may nominally apply a compressive load on the spring-loaded linkage 516.

Upon release of the pin 512, the spring 514 may apply force to move the first bar 518 toward the chainsaw guide bar. The first bar 518 in turn may apply force to the second bar 520, which may cause the first pivot pin 522 to rotate about its axis and move laterally. In some embodiments, the first pivot pin 522 may be coupled to a hand guard 528 so that when the first pivot pin 522 moves laterally, the hand guard 528 pivots toward the guide bar of the chainsaw.

A band brake 530 may be wrapped at least partially around a drum 532 attached to a chain drive sprocket 534. The band brake 530 may be operably coupled to the spring-loaded linkage 516, e.g., at the first bar 518. When the pin 512 is removed, the spring 514 may apply force to the first bar 518, which in turn may cause the band brake 530 to be more tightly wound around drum 532. The band brake 530 may be tightened around the drum 532 in the same direction that the drum 532 rotates, which may allow the frictional forces to further tighten the band brake 530 around the drum 532. Although a band brake is used in this embodiment, another type of brake, such as a disc brake or a clutch brake, may be used.

In some embodiments, after the brake system 500 is engaged, it may be reset to an operational configuration. As noted above, in FIG. 5, the first pivot pin 522 may be connected to the hand guard 528. After the braking system 500 is actuated, the hand guard 528 may be pulled away from the blade of the chainsaw. This in turn may cause the first pivot pin 522 to move laterally back to its original position, and may in turn cause the second bar 520 to move back toward the rear of the chainsaw. This rearward movement of the second bar 520 may exert rearward force on the first bar 518, which may compress the spring 514, loosen the band brake 530 from around the drum 532, and may ultimately maneuver the pin 512 back into its retained position (e.g., back into a hole).

When the pin 512 slips back into its retained position, the second end 510 of the lever bar 506 may move back into its original position, which in turn may pivot the lever bar 506 and return the first end 508 back into its original position. The solenoid 504 may include a tension spring (not shown) on its backside that pulls it back after being actuated. Thus, the first end 508 may return to its original position without additional force. At this point, the chainsaw may once again be operational.

In various embodiments, the microprocessor (e.g., 410), sensors (e.g., 412 and 414), and solenoid 504 may operate on a different circuitry (e.g., a cutoff switch) than the chainsaw engine (e.g., 420). When the microprocessor (e.g., 410) detects a kickback, it may output a signal (e.g., 5VDC) to a relay. The relay may simultaneously send a signal to the engine (e.g., 420) to shut down and apply power to the solenoid (e.g., 504) to actuate the band brake 530. Power may continue to flow through these systems until the pin 512 has fully released the spring-loaded linkage 516. A separate power shutoff may be attached to the front hand guard 528. When the spring-loaded linkage 516 is released, the hand guard 528 also may move forward.

In various embodiments, other types of braking systems may be used. For example, a solenoid may act directly on a band brake with no intervening parts. In some embodiments, a solenoid may be actuated to decouple a sprocket from a shaft. In some embodiments, a solenoid may project a pin into a sprocket.

In some embodiments, an LED indicator (not shown) may be provided to notify an operator that the band brake safety system (e.g., as shown in FIG. 5) has been engaged. The light may turn on when the brake is actuated and may remain on until the chainsaw is reset.

The stopping time of devices using discloses systems and methods may be faster than devices that comport with an industry standard stopping time of 120 milliseconds, once a hand guard portion of an inertial brake is actuated. For example, it has been observed that an average reaction time for actuating an inertial brake may be 40 ms. Thus, the total time required may be 160 ms. In contrast, a reaction time of a device using disclosed systems and methods may be approximately 40-60 ms. This may translate into a reduction in chainsaw body angular movement by 60-80%, depending on the type of chainsaw.

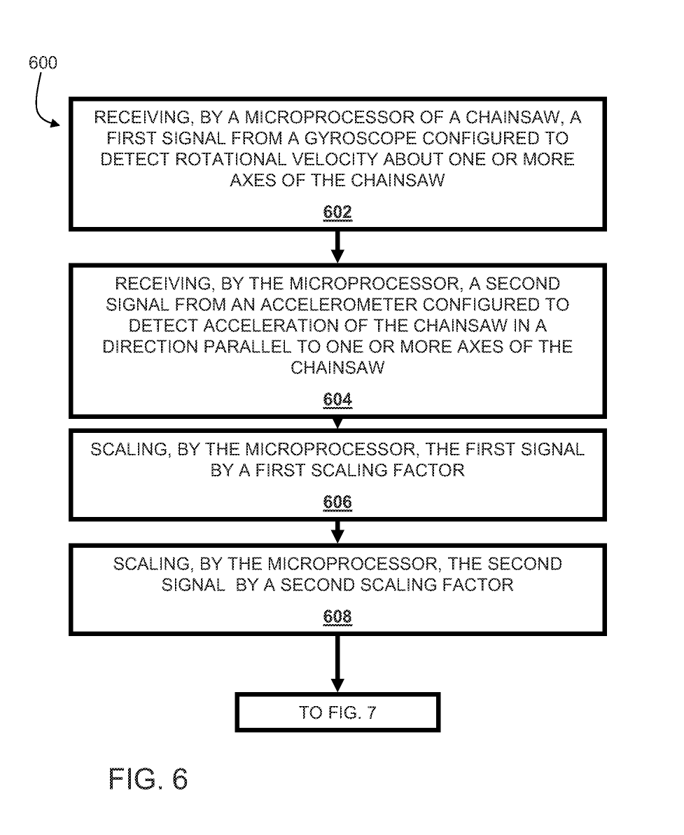

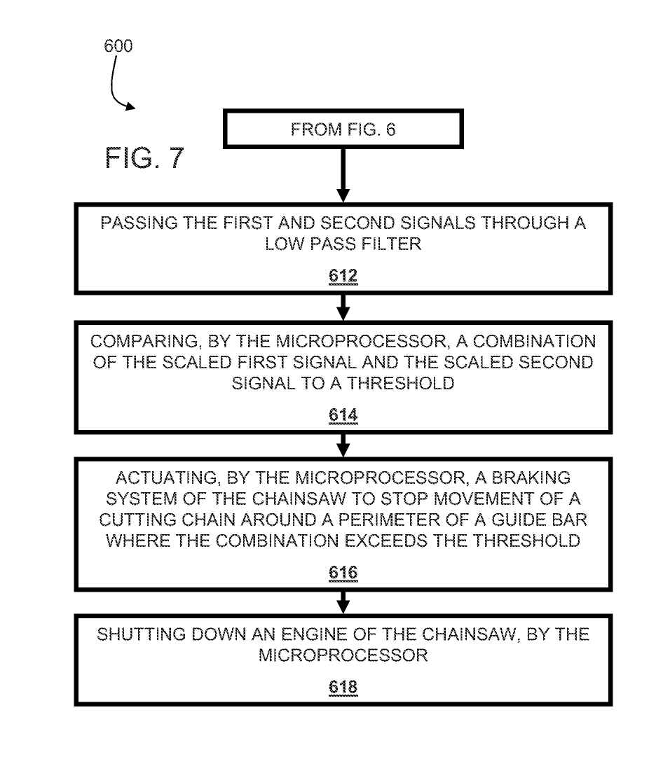

An example method 600 of detecting kickback and stopping a cutting member such as a cutting chain of a chainsaw is shown in FIGS. 6-7, in accordance with various embodiments. While shown in a particular order, this is not meant to be limiting. These operations may be performed in different orders in various embodiments, and in some embodiments, one or more operations may be omitted and/or added without departing from the disclosure.

At 602, a microprocessor (e.g., 410) may receive a first signal from a gyroscope (e.g., 414) configured to detect rotational velocity about one or more axes (e.g., the Z-axis of FIG. 3) of a chainsaw. At 604, the microprocessor may receive a second signal from an accelerometer (e.g., 412) configured to detect acceleration of the chainsaw in a direction parallel to one or more axes (e.g., the Y-axis of FIG. 3) of the chainsaw.

At 606, the first signal may be scaled, e.g., by the microprocessor 410, by a first weighting factor. At 608, the second signal may be scaled, e.g., by the microprocessor 410, by a second weighting factor. Weighting factors may be selected for various reasons. For example, a professional-grade chainsaw may use weighting factors that are different than those used by a simpler or less powerful chainsaw (e.g., as might be used by an ordinary consumer). Weighting factors for a particular chainsaw may be determined based on testing, as will be described below. Once suitable weighting factors are determined for a particular chainsaw, in some embodiments, those factors may be programmed into circuitry of the chainsaw prior to sale. In some embodiments, the factors may be adjustable by an operator of the chainsaw after purchase.

At 612, the first and/or second signals may be passed through low pass filters (e.g., 416), to attenuate the high frequency, high magnitude signals that may be produced by the chainsaw during use. This may reduce false alarms. At 614, the microprocessor (e.g., 410) may compare a combination of the scaled first and second signals to a threshold. For example, in some embodiments, it may be determined whether the combination of the signals exceeds a threshold of 60% of a particular value for an average kickback event.

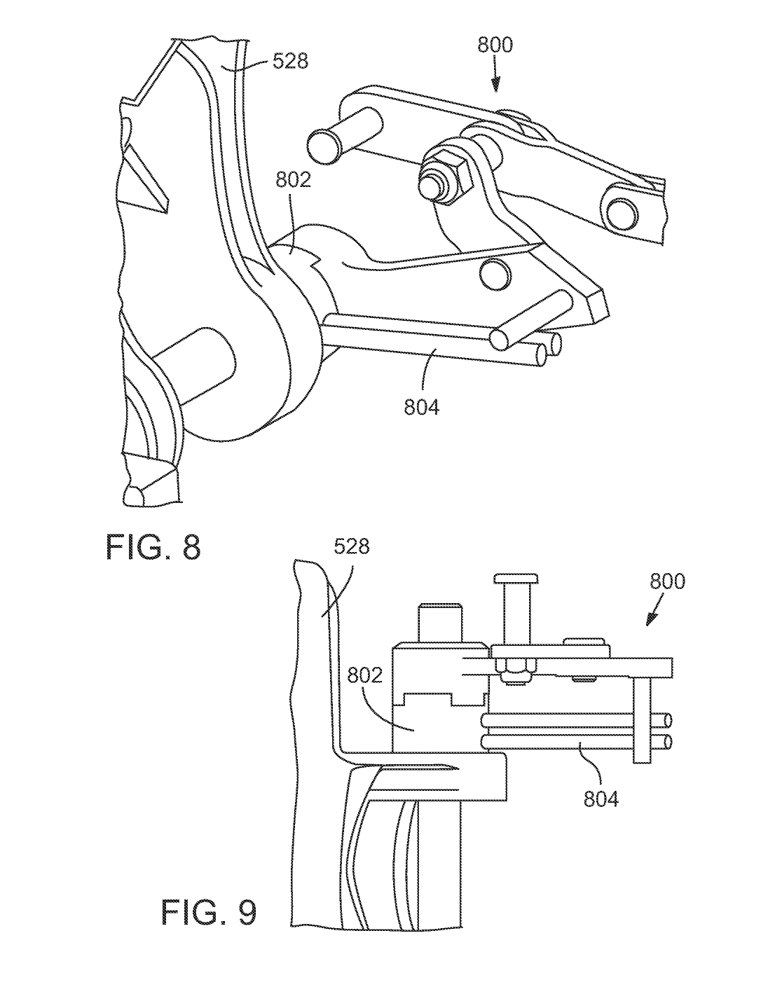

At 616, the microprocessor may actuate a braking system (e.g., 500) to stop movement of a cutting chain around a perimeter of a guide bar of a chainsaw where the combination of the first and second signals exceeds a predetermined threshold. In some embodiments, at 618, an engine of the chainsaw may also be shut down. FIGS. 8 and 9 depict an example secondary system 800 for actuating a brake system (e.g., 500) that may be attached to the hand guard (e.g., 528). A keyed connector 802 may allow the hand guard 528 to be pushed forward. A compression spring 804 may nominally provide resistance to prevent the hand guard 528 from being moved forward unintentionally. When the hand guard 528 has rotated a predetermined number of degrees, such as 5°, it may actuate a switch (not shown) that then actuates a brake system (e.g., 500). This system may be actuated when a user presses the hand guard 528 forward. This may be an additional failsafe mechanism in the event that the MEMS sensors fail to detect a kickback event.

Other methods may be implemented to detect kickback. In one embodiment, it was observed that a magnitude of acceleration observed in the Y-direction during kickback was opposite in sign, but similar in magnitude, to accelerations observed in the X-direction. It was also observed that the values of accelerations during normal cutting seemed to be similar in magnitude, but in the same direction. Accordingly, equation (1), below, may be used to account for this observation.

KBₛᵢₘₚₗₑ=A_{y}−Aₓ (1)

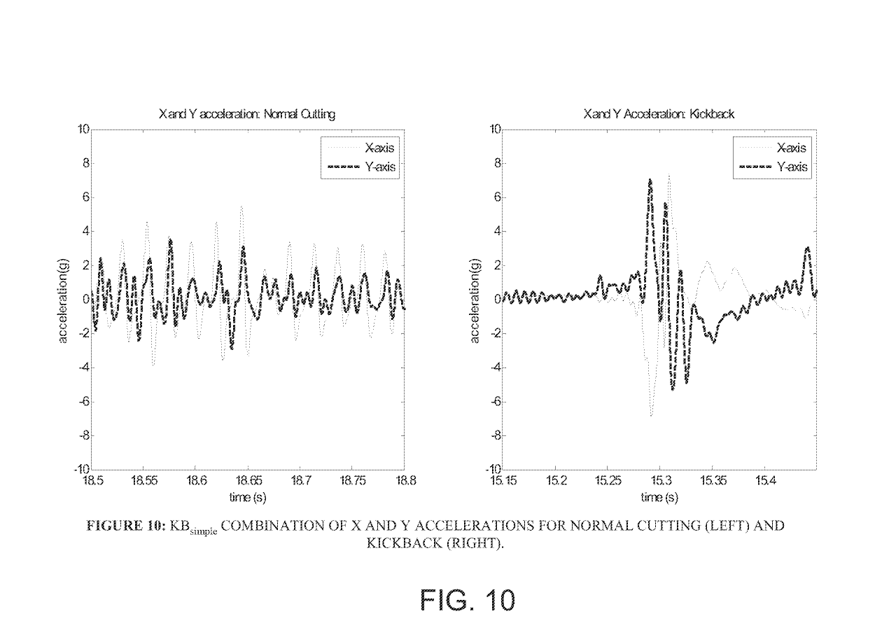

Ay and Ax may be accelerations observed along the Y and X axes, respectively. Combining the signals using equation (1) gives the results seen in FIG. 10. The chart on the left may represent X and Y acceleration during normal operation. The chart on the right may represent X and Y acceleration during kickback. Equation (1) may have an effect of attenuating the signal of normal cutting while amplifying the signal observed during kickback.

Using equation (1) as a starting point, testing data was used to optimize the method. As with equation (1), the optimized method may combine multiple signals into one signal that can be monitored during chainsaw use. If a value of KB above a kickback threshold is detected, a braking system (e.g., 500) may be actuated. Acceleration along the X-axis (Ax) may be subtracted from a sum of the acceleration along the Y-axis (Ay) and the rotational velocity about the Z-axis (Gz) (observed by, e.g., a gyroscope). Each of the values Ay, Ax, and Gz may then be multiplied by weighting factors, a, b, and c, respectively. Equation 2 shows the combination of these six values to obtain the detection equation (2).

KB=a·A_{Y}−b·Aₓ+c·G_{Z} (2)

To optimize equation (2), values of a, b and c were varied and the resulting KB value was ranked for effectiveness. Values of a and b were varied through the use of nested “for” loops from values close to 0, to 2 for the accelerometers, and from 0 to 0.2 for the gyroscopes. The gyroscopes were given a different range of weighting factors to keep all values within an order of magnitude of one another. The data was divided into two categories: normal cutting and kickback events. At each increment of a, b, and c, the data for a kickback event and all of the data for normal cutting were run through equation (2). To rank effectiveness of each equation, the maximum value for the kickback signal (KBₘₐₓ) and the maximum value found in the normal cutting signal (Normₘₐₓ) were compared using equation 3.

$$Dif = \frac{{kb}_{max} - {Norm}_{max}}{{Norm}_{max}} \qquad ( 3 )$$

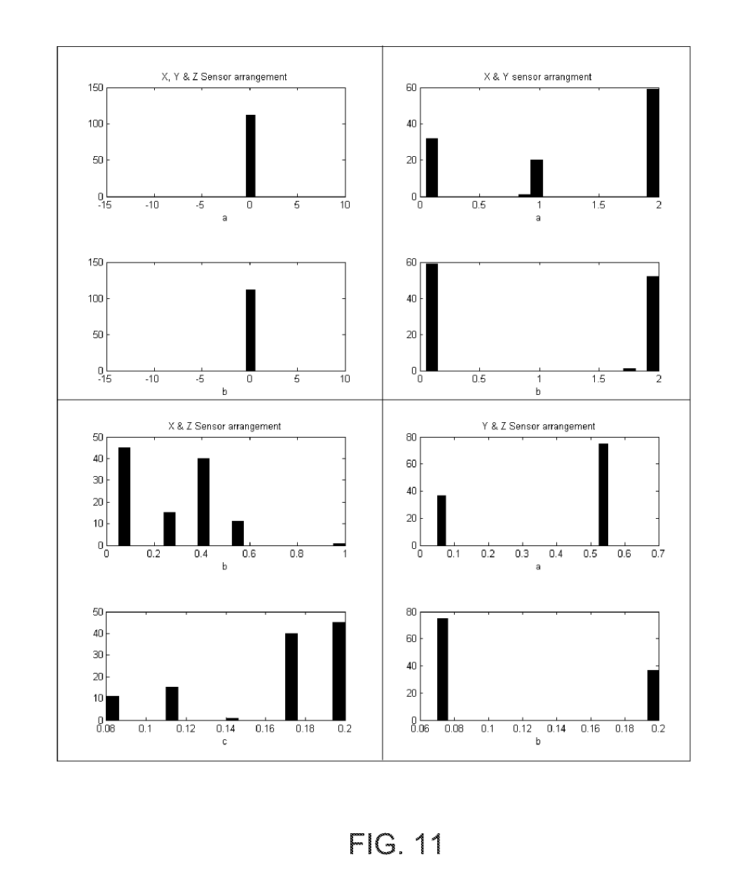

Dif is the ranking term for each value of a, b and c. It is the percentage difference between the peak of the kickback event and the highest value obtained for normal cutting. In one test, c was held constant while a and b were varied about it. A value of Dif was stored for each value of a and b. This process of iterating values of a and b was repeated for each kickback event. The max value of Dif (Difₘₐₓ) was noted and recorded for each kickback event. Histograms were created for the values of a, b and c and the most prominent values were then selected as the weighting factors. FIG. 11 in the Annex shows histograms in accordance with various embodiments that may be used to select the optimal values of a, b, and c, as well as histograms for different sensor arrangements.

The table illustrated in FIG. 12 presents example weighting factors for each sensor arrangement as well as pertinent statistics, in accordance with various embodiments. In FIG. 12, “X” and “Y” in the first and fifth columns represent an accelerometer measuring acceleration of a chainsaw in a direction parallel to the X-axis and the Y-axis, respectively, as shown in FIG. 3. “Z” represents a gyroscope measuring rotational velocity about the Z-axis. Weighting factor a may be used to scale a signal from the accelerometer measuring acceleration in a direction parallel to the X-axis. Weighting factor b may be used to scale a signal from the accelerometer measuring acceleration in a direction parallel to the Y-axis. Weighting factor c may be used to scale a signal from the gyroscope measuring rotational velocity in a direction parallel to the Z-axis.

For each arrangement, kickback events were run back through equation (2) and the average difference between kickback and normal cutting was recorded. The table contains the values for a, b, and c for each test, and the corresponding mean, minimum and maximum values of Difₘₐₓ. For some of the sensor arrangements, certain kickback events registered with lower values than were found in normal cutting. In these cases, a negative value of Difₘₐₓ was found. The last column in the table of FIG. 12 shows the percentage of kickback events that registered with a positive value of Difₘₐₓ.

The data in the table of FIG. 12 is divided into two different sets. One section consisted of horizontal, vertical and bias cuts, and the other of knot bumping tests. The knot bumping samples were observed to have signals very similar to those observed during kickback.

Based on the results in the table of FIG. 12, one suitable sensor arrangement that may be used in various embodiments includes only a gyroscope to sense rotational velocity about the Z-axis. In some embodiments, the use of a single gyroscope enabled kickback detection that is an order of magnitude more accurate than kickback detection enabled by embodiments that only include accelerometers. This may be because a signal produced by a gyroscope exhibits less noise than signals produced by accelerometers.

However, in various embodiments, one or more accelerometers may also be included in conjunction with the Z-axis gyroscope. In some embodiments, signals from the accelerometers may be out of phase from each other by, for instance, 180°. Though the operational characteristics of these two configurations are very similar, the accelerometers may be less affected by broader motions caused by an operator, while the gyroscope may be less susceptible to high amplitude, high frequency noise that is associated with cutting.

This is illustrated by the results for the X-axis, Y-axis and Z-axis sensor arrangement in the table of FIG. 12. While other sensor arrangements showed worse performance during knot bumping, the double-accelerometer configuration improved. This may be due to the fact that, during knot bumping, the chainsaw performs very little cutting. Because knot bumping requires the operator to swing the chainsaw like an axe, the chainsaw experiences large, broad motions, but very little high vibration noise. The gyroscope detects these broad motions more readily, which adds a small potential for false kickback detection. Adding a Y-axis accelerometer may reduce the sensitivity of the system to large movements and yet may provide a system that can detect the motions of kickback.

The weighting in FIG. 12 may be suitable for a particular type or model of chainsaw. It should be understood, however, that other weighting factors may be suitable for other chainsaws. Moreover, while these weighting factors listed as precise numbers, other numbers within various ranges may also be suitable, and the numbers may be adjusted so long as the ratios between them are maintained.

For example, in one embodiment in FIG. 12 including a gyroscope and an accelerometer configured to detect acceleration along the Y-axis, a ratio between a weighting factor (0.2) applied to the signal from the gyroscope and a weighting factor (0.05) applied to a signal from the accelerometer may be approximately 4:1. In another embodiment including a gyroscope and an accelerometer configured to detect acceleration along the X-axis, a ratio between a weighting factor (0.175) applied to a signal from the gyroscope and a weighting factor (0.4) applied to a signal received from the accelerometer may be between 1:2 and 1:3 (e.g., approximately 1:2.286). In an embodiment including a gyroscope and two accelerometers, one configured to detect acceleration along the X-axis and the other configured to detect acceleration along the Y-axis, a ratio between a weighting factor (1.0) applied to a signal from the gyroscope and a weighting factor (0.1) applied to signals received from the accelerometers may be approximately 10:1.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

What is claimed is:

1. A chainsaw comprising:
a housing containing an engine;
a guide bar extending from the housing;
a cutting chain that is movable by the engine around a perimeter of the guide bar;
a gyroscope configured to detect rotational velocity of the chainsaw about an axis of the chainsaw; and
a microprocessor configured to cause movement of the cutting chain to stop in response to a signal received from the gyroscope.

2. The chainsaw of claim 1, wherein the axis is a first axis and the signal is a first signal, the chainsaw further comprising:
an accelerometer configured to detect acceleration of the chainsaw in a direction parallel to a second axis of the chainsaw;
wherein the microprocessor is further configured to:
scale the first signal received from the gyroscope by a first weighting factor;
scale a second signal received from the accelerometer by a second weighting factor;
compare a combination of the scaled first signal and the scaled second signal to a threshold; and
cause movement of the cutting chain to stop where the combination exceeds the threshold.

3. The chainsaw of claim 2, wherein the first and second weighting factors are selected to maximize detection of actual kickback and minimize false alarms of kickback produced during normal operation of the chainsaw.

4. The chainsaw of claim 2, wherein the second axis is defined generally by the guide bar and is approximately perpendicular to the first axis.

5. The chainsaw of claim 4, wherein a ratio between the first weighting factor and the second weighting factor is between 1:2 and 1:3.

6. The chainsaw of claim 2, wherein the second axis is approximately perpendicular to both the first axis and a third axis defined by the guide bar.

7. The chainsaw of claim 6, wherein a ratio between the first weighting factor and the second weighting factor is approximately 4:1.

8. The chainsaw of claim 2, wherein the accelerometer is a first accelerometer and the second axis is approximately perpendicular to the first axis, the chainsaw further comprising a second accelerometer configured to detect acceleration of the chainsaw in a direction parallel to a third axis of the chainsaw that is perpendicular to both the first and second axes;
wherein the microprocessor is further configured to scale a third signal received from the second accelerometer by a third weighting factor.

9. The chainsaw of claim 8, wherein the signals from the first and second accelerometers are 180° out of phase.

10. The chainsaw of claim 8, wherein a ratio between the first weighting factor and both the second weighting factor and the third weighting factor is approximately 10:1.

11. The chainsaw of claim 2, wherein the microprocessor is further configured to cause the engine to shut down where the combination exceeds the threshold.

12. The chainsaw of claim 2, wherein one or more of the first signal and the second signal is passed through a low pass filter before being received by the microprocessor.

13. The chainsaw of claim 12, wherein the low pass filter has a frequency of about 150 Hz.

14. A method, comprising:
receiving, by a microprocessor of a chainsaw, one or more signals from a gyroscope configured to detect rotational velocity about one or more axes of the chainsaw; and
activating, by the microprocessor, a braking system of the chainsaw to stop movement of a cutting chain around a perimeter of a guide bar in response to receiving the signal from the gyroscope.

15. The method of claim 14, further comprising:
scaling, by the microprocessor, a first signal received from the gyroscope by a first weighting factor;
scaling, by the microprocessor, a second signal received from an accelerometer configured to detect acceleration in one or more directions, by a second weighting factor;
comparing, by the microprocessor, a combination of the scaled first signal and the scaled second signal to a threshold; and
activating, by the microprocessor, the braking system of the chainsaw to stop movement of the cutting chain around the perimeter of the guide bar where the combination exceeds the threshold.

16. The method of claim 15, wherein the gyroscope is configured to detect rotational velocity about a Z-axis of the chainsaw and the accelerometer is configured to detect acceleration of the chainsaw in a direction parallel to a Y-axis of the chainsaw.

17. The method of claim 15, wherein a ratio between the first weighting factor and the second weighting factor is between 1:2 and 1:3.

18. The method of claim 15, wherein a ratio between the first weighting factor and the second weighting factor is approximately 4:1.

19. The method of claim 15, further comprising shutting down an engine of the chainsaw, by the microprocessor, where the combination exceeds the threshold.

20. The method of claim 15, further comprising passing the first and second signals through one or more low pass filters before sending the first and second signals to the microprocessor.

21. The method of claim 15, wherein the accelerometer is a first accelerometer, the method further comprising:
scaling, by the microprocessor, a third signal received from a second accelerometer configured to detect acceleration in one or more directions, by a third weighting factor;
wherein the gyroscope is configured to detect rotational velocity about a Z-axis of the chainsaw, the first accelerometer is configured to detect acceleration of the chainsaw in a direction parallel to an X-axis of the chainsaw, and the second accelerometer is configured to detect acceleration of the chainsaw in a direction parallel to a Y-axis of the chainsaw.
